(19) United States
(12) Patent Application Publication
(10) Pub. No.: US 2024/0058892 A1
(43) Pub. Date: Feb. 22, 2024

(54) AN INTEGRATED X-RAY IMAGING AND LASER ABLATING SYSTEM FOR PRECISION MICROMACHINING

(71) Applicants: Meng Keong LIM, Singapore (SG); Si Ping ZHAO, Singapore (SG)

(72) Inventors: Meng Keong LIM, Singapore (SG); Si Ping ZHAO, Singapore (SG)

(21) Appl. No.: 18/259,834

(22) PCT Filed: Jan. 8, 2022
(86) PCT No.: PCT/SG2022/050009

§ 371 Date: Jun. 29, 2023

(30) Foreign Application Priority Data
Mar. 3, 2021 (SG) 10202102165T

(51) Int. Cl. B23K 26/03; B23K 26/16; B23K 26/402

(52) U.S. Cl. CPC B23K 26/032; B23K 26/16; B23K 26/402; B23K 2101/40

(57) ABSTRACT

A method and system for precision micromachining by utilizing X-ray imaging and laser ablation. X-ray is utilized for imaging and locating one or more buried features or defects in semiconductor packages or devices, while laser ablation is accurately targeted at the area of interest to achieve precise and accurate micromachining. X-ray imaging and laser ablation can either occur simultaneously or in turns during the precision micromachining process.

### TECHNICAL FIELD OF THE INVENTION

The present invention relates to a method and a system of using X-ray and laser for precision micromachining. This micromachining can be utilized for various applications such as structural analysis, materials characterization or electrical probing. In some embodiments, this invention relates to cross sectioning of electronic devices or packages to precisely exposed buried microscopic structures or defects for process monitoring or failure analysis.

### BACKGROUND INFORMATION

Semiconductor devices have been mass manufactured since the 1960s and current advanced semiconductor devices are built with minimum structure sizes or Critical Dimensions (CD) of down to 5 nanometers. Semiconductor devices that are in the form of integrated circuit chips are commonly enclosed in plastic compounds. The enclosed integrated circuit chips are known as semiconductor packages or electronic packages, where the integrated circuit chips are electrically connected to the pins on the packages by a network of metal interconnections.

In order to obtain a high yield of semiconductor devices or packages, it is necessary to closely monitor variations in any fabrication step that may lead to defects or yield loss. Therefore, various inspection and analysis metrologies are often requested for process monitoring and structural analysis of these fabrication steps. Post fabrication, failed semiconductor devices or packages that are returned from the field are analyzed for their failure root causes and mechanisms. These microscopic structures or defects to be inspected and analyzed are often, if not always, enclosed or buried. The semiconductor devices or packages will thus be physically cross sectioned to expose the microscopic structures or defects for visual inspection and analysis.

Manual cross section is usually carried out by a skilled worker who will hold the semiconductor device or package by hand and then grind and polish it with abrasive papers. Frequent visual inspection is carried out in-between material removal so as to check if the structure or defect of interest is exposed or still buried. Grinding is not only a tedious sample preparation process, the other drawbacks of this method include inducing artifacts and possibility of over-grinding. As the sizes of structures and defects shrink in advanced semiconductor devices and packages, the difficulty to grind and precisely expose them increases. Focused ion beam (FIB) milling or plasma FIB milling can produce precise cross sections of microscopic structures or defects when grinding has a low success rate. However, these millings are time consuming and expensive processes where hours could be required to achieve precise cross sections of the structures or defects of interest. In-chamber large area milling that removes a lot of organic materials could also lead to contamination of the vacuum chamber and therefore increase the frequency of tool servicing and maintenance.

A method that can quickly and accurately perform this precision cross section and micromachining in a non-vacuum chamber is therefore needed. This method could also be utilized on non-semiconductor devices so long the cross sectional sample preparation is needed.

### SUMMARY OF THE INVENTION

This invention is about a method and a system incorporating both high image resolution X-ray apparatus and laser ablating apparatus for precision micromachining. The X-ray imaging enables localization of the area of interest for laser ablation to achieve the precise micromachining of the desired site, size and shape.

This system allows inspection of one or more buried microscopic features or defects in a sample using X-ray imaging technique, where a laser beam can then be directed to perform micromachining to precisely expose the buried microscopic features or defects. The system can also provide immediate imaging of the laser machining process, where X-ray imaging and laser ablation can occur simultaneously or in turns during the micromachining process to ensure that the laser ablation process is monitored and well controlled to achieve the desired results and precision. The present invention also provides a method to cross section semiconductor devices which overcome the limitations of grinding and ion beam milling.

In an exemplary embodiment of the present invention, a semiconductor device that requires cross sectioning is inspected using X-ray and then cross sectioned using a laser in the same chamber. The sample is mounted on a stage that allows X-ray to penetrate easily. The stage can be made of composite materials such as carbon fiber or glass fiber composite. The workflow starts with using CCTV to navigate to the region of interest on the sample. The buried microscopic feature or defect is then located using X-ray imaging, where the X-ray source and detector are directly below and above the sample respectively. Next, the X-ray source and detector are tilted and the laser source is positioned above the sample. The line of sight from sample to X-ray source and the line of sight from sample to laser source form an angle that can be any value between 0 degree and 180 degrees, and the two lines of sight have a common point on the sample. Such setup allows simultaneous X-ray imaging and laser ablation of the sample. A laser beam is then generated to micromachine the sample and an exhaust is positioned next to the ablated area to remove the by-products generated during laser ablation. This localized exhaust can minimize by-products redeposition and contamination to the chamber and other apparatuses. CCTV and X-ray are used to monitor the progress of micromachining for better control of the process. Finally, laser ablation is stopped when the desired precision micromachining is achieved. In a further embodiment, the position of the X-ray source and detector can be swapped.

In a different embodiment where X-ray imaging and laser ablation occurs in turns, the X-ray source, X-ray detector, laser source and sample are positioned along the same straight line during laser ablation. CCTV is used to monitor the laser ablation process since X-ray imaging is obstructed by the laser source. The laser source is moved out of the line during X-ray imaging. As and when required, laser ablation can be paused so that X-ray imaging can be carried out to determine if the micromachining has achieved the desired results.

In another embodiment where X-ray imaging and laser ablation occurs in turn, the centerline of the laser source is parallel to that of the X-ray source and X-ray detector. The sample is aligned to the centerline of the X-ray source and detector during X-ray imaging. The sample is then moved so that it is aligned to the centerline of the laser source during laser ablation. Laser ablation is monitored using CCTV and the laser ablation can be paused whenever X-ray imaging is required. In this setup, the sample is moved in between X-ray imaging and laser ablation.

### BRIEF DESCRIPTION OF THE DRAWINGS

FIG. 1a is a schematic representation of a semiconductor package that has a defect in a buried feature.

FIG. 1B is a schematic representation of a cross sectioned semiconductor package where the defect is exposed for failure analysis.

FIG. 2a is a schematic representation of a semiconductor package that has a buried feature of interest. X-ray imaging is carried out to locate the feature of interest.

FIG. 2b is a schematic representation of an X-ray image that captures a defect in a buried feature of the semiconductor package. A box pattern is drawn on the X-ray image to define the area to be laser ablated.

FIGS. 3a, 3b and 3c are schematic representations of the method and system where X-ray imaging and laser ablation occurs simultaneously. Firstly, the semiconductor package is subjected to X-ray inspection and imaging as shown in FIG. 3a. Secondly, the semiconductor package is subjected to laser ablation, where the X-ray source and detector are tilted, as shown in FIGS. 3b and 3c.

FIG. 4 presents the workflow for the method where X-ray imaging and laser ablation occurs simultaneously.

FIG. 5 is a schematic representation of the method and system where X-ray imaging and laser ablation occurs in turns, that involves moving the laser source between X-ray imaging and laser ablation.

FIG. 6 is a schematic representation of the method and system where X-ray imaging and laser ablation occurs in turns, that involves moving the sample between X-ray imaging and laser ablation.

FIG. 7 presents the workflow for the method where X-ray imaging and laser ablation occurs in turns (i.e. non-simultaneously).

FIG. 8 presents the key apparatus of the integrated system that is defined in this invention.

FIG. 9 presents the key features that are integrated together to achieve the precision micromachining that is defined in this invention.

### DETAILED DESCRIPTION

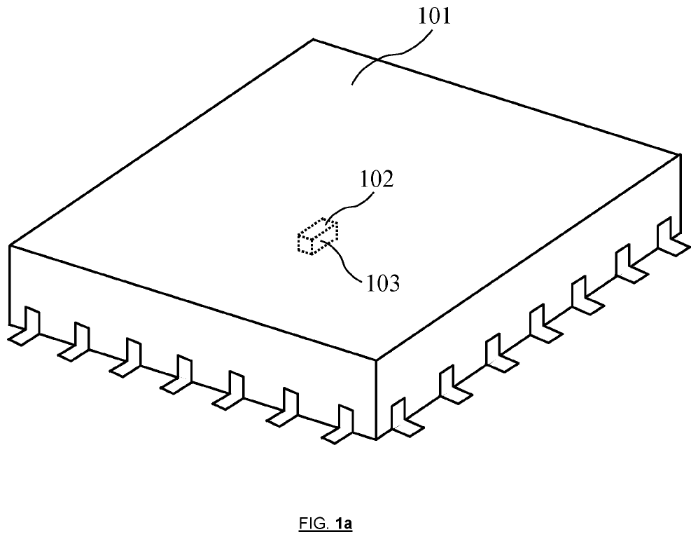

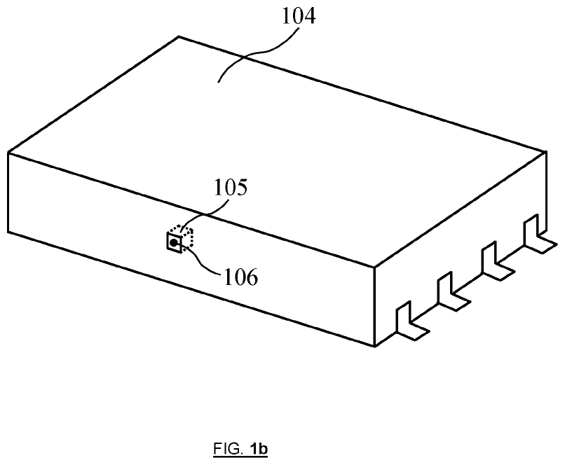

FIG. 1a shows a schematic representation of a semiconductor package 101 that has a buried feature 102. The feature 102 has a defect 103 that causes the device to fail or perform out of specification. An example of such buried features is, copper redistribution layers (RDL), which are responsible for transmitting power and signal within the semiconductor package. These copper RDL could fail due to the formation of a defect, such as a crack or a void. In order to investigate the failure root cause and mechanism, the semiconductor package is cross sectioned 104 (FIG. 1B) so as to expose the buried feature 105 and defect 106 for visual inspection and analysis.

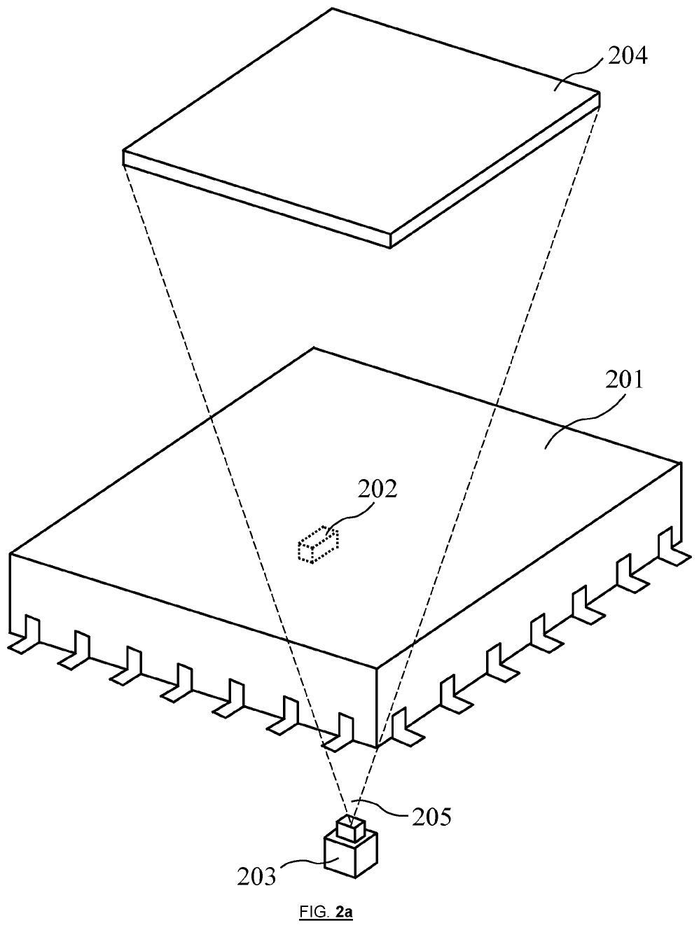

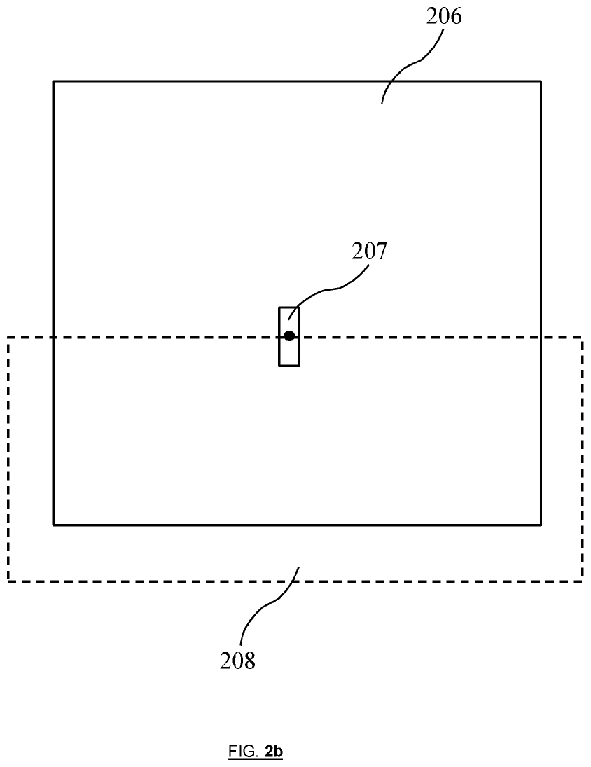

Before cross sectioning can be carried out, the buried feature or defect of interest has to be identified and located. Electrical testing is usually performed to identify the failure mode and the feature that caused the semiconductor package to fail. The failure modes such as electrical short or open can occur anywhere along the length of copper RDL. The exact location of the defect has to be determined before cross sectioning can be carried out. X-ray imaging is a technique that can be used to locate the defect since X-ray can penetrate the semiconductor package and provide internal details of the package. The defect will absorb different amounts of X-ray as compared to other parts of the copper RDL and hence, the exact location of the defect will show up in the X-ray image. FIG. 2a shows a schematic representation of a semiconductor package 201 during X-ray imaging, where the package has a defective buried feature 202. The X-ray source 203 is directly below the package 201, while the X-ray detector 204 is directly above the package 201. A cone shape X-ray beam 205 is emitted from the X-ray source 203 during X-ray imaging. The X-ray beam penetrates the semiconductor package 201 and different amounts of X-ray are absorbed by the defective buried feature 202 and package 201. The X-ray detector 204 senses the transmitted X-ray and then produces an X-ray image 206 as shown in FIG. 2b. The X-ray image 206 shows the shape, size and location of the defective buried feature of interest 207. The semiconductor package will then be cross sectioned and a part of it will be removed, as shown by the box pattern 208 that is drawn on the X-ray image 206 in FIG. 2b.

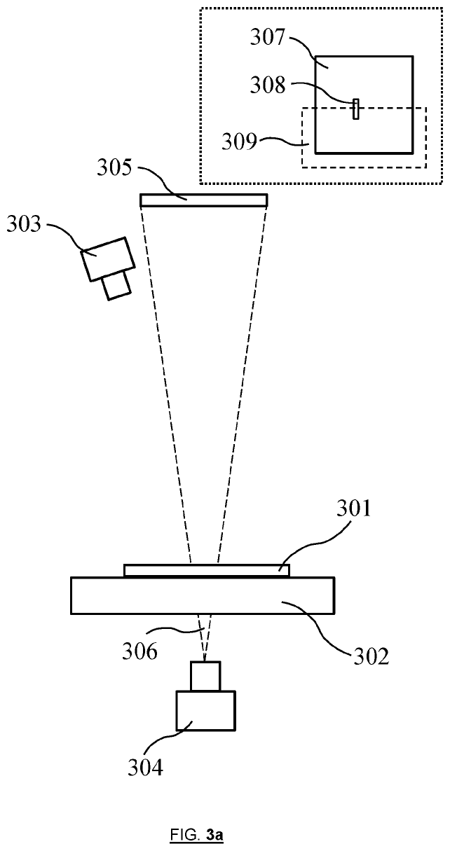

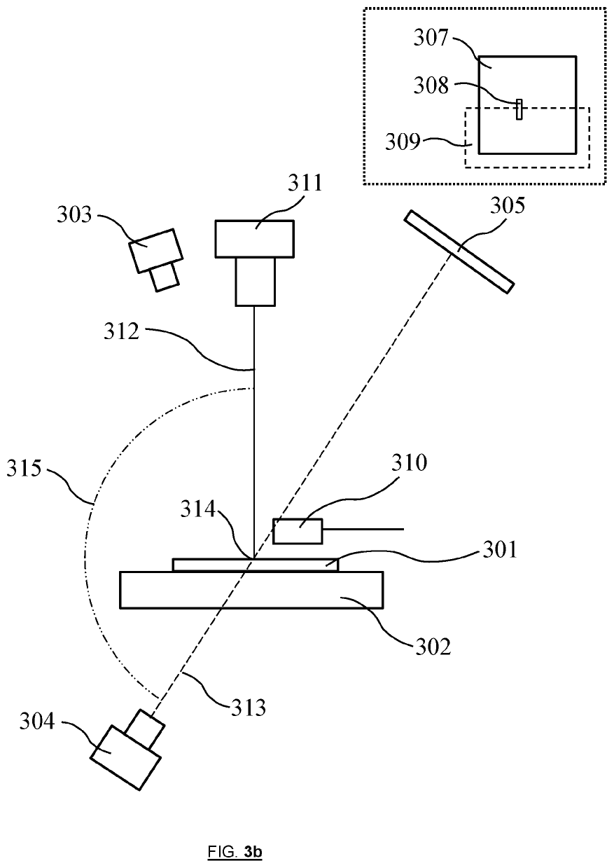

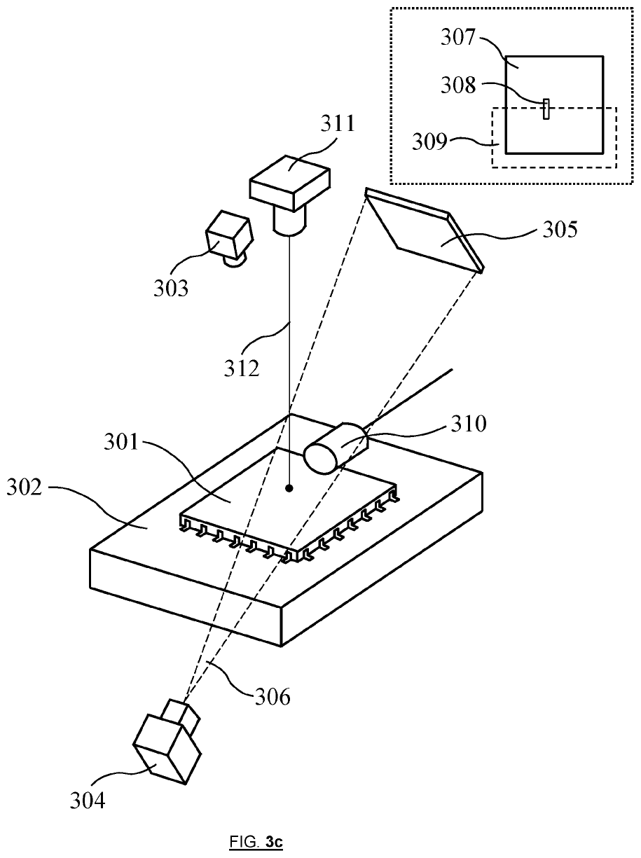

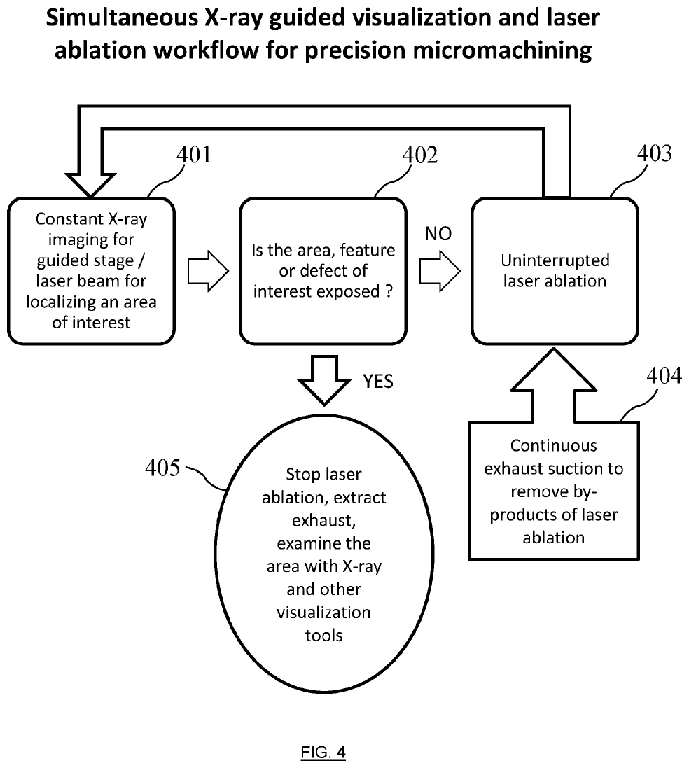

FIGS. 3a, 3b and 3c present an exemplary embodiment of a system in accordance with this invention. In this embodiment, a semiconductor package 301 that requires cross section micromachining is mounted on an X-ray transparent stage 302. With the help of a closed circuit television (CCTV) 303, the system navigates and approximately aligns the region of interest on the semiconductor package 301 with the X-ray source 304 and X-ray detector 305. As shown in FIG. 3a, the X-ray source 304 and detector 305 are below and above the semiconductor package 301 respectively. At this point, X-ray imaging is carried out in order to locate the feature or defect of interest. The X-ray source 304 emits an X-ray cone beam 306 that penetrates and transmits through the semiconductor package 301. An X-ray image 307 is produced and displayed on a computer monitor, where the exact location of the feature or defect of interest 308 can be identified from the X-ray image. A pattern 309 is then drawn on the X-ray image to define the area of micromachining, as per FIG. 2b. After the part of the semiconductor package that has to be micromachined is defined, the X-ray source 304 and detector 305 are tilted and then the laser source 311 is positioned above the semiconductor package 301, as shown in FIG. 3b. The laser beam 312 and centerline 313 of the X-ray source 304 and detector 305 intersect and have a common point 314 on the semiconductor package 301. This setup allows simultaneous X-ray imaging and laser ablation during the micromachining process. The angle 315 between the laser beam 312 and centerline 313 can be any value between 0 degree and 180 degrees, where the optimal angle 315 for the embodiment shown in FIG. 3b is expected to be between 120 degrees and 180 degrees. A localized exhaust 310 is also inserted and positioned beside the area of laser ablation so that the by-products that are generated during laser ablation can be removed immediately. Finally, the semiconductor package 301 is ablated by a laser beam 312 and the process is constantly monitored by X-ray imaging so as to produce a semiconductor package that is accurately and precisely cross sectioned. FIG. 3c shows a 3D schematic diagram that illustrates the simultaneous X-ray imaging and laser ablation micromachining system. FIG. 4 presents the workflow of the embodiment that is illustrated in FIGS. 3a, 3b and 3c, which is in accordance with this invention. During the precision micromachining process, constant X-ray imaging provides a guide for the laser beam to accurately and precisely ablate an area of interest 401. X-ray imaging also provides information on whether the area, feature or defect of interest is exposed 402. Laser ablation continues in an uninterrupted manner 403 as long as the area, feature or defect of interest is not exposed. At the same time, a localized exhaust removes the by-products 404 that are generated during laser ablation. When the area, feature or defect of interest is exposed 402 as determined from the constant X-ray imaging 401, the laser ablation process is ceased automatically by the computer software or manually by a human operator 405. The exposed feature or defect can then be inspected and analyzed by other tools.

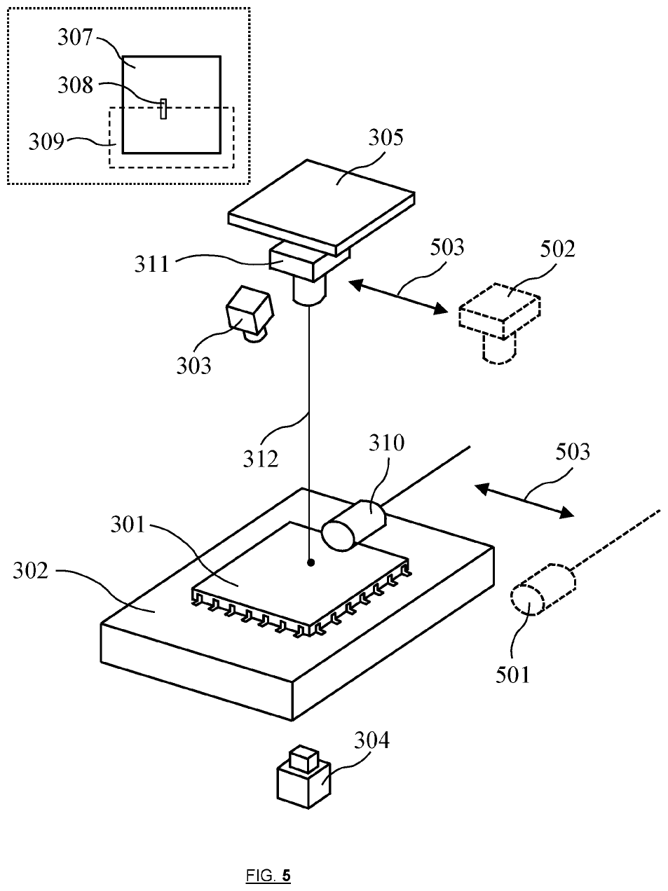

FIG. 5 shows an embodiment of a system where X-ray imaging and laser ablation occurs in turns during the precision micromachining process. In this embodiment, the semiconductor package 301, X-ray source 304, X-ray detector 305 and laser source 311 are positioned along the same straight line. Precision micromachining begins with mounting a semiconductor package 301 onto an X-ray transparent stage 302. CCTV 303 is then used to navigate to the region of interest on the package 301. During X-ray imaging, the X-ray source 304 and X-ray detector 305 are directly below and above the semiconductor package 301 respectively. The laser source 502 and localized exhaust 501 are moved 503 aside during the X-ray imaging step. When the feature or defect of interest 308 is located from the X-ray image 307 and the pattern 309 to be micromachined is drawn on the X-ray image 307, the laser source 311 is moved 503 and positioned above the package 301. The localized exhaust 310 is also moved 503 and positioned beside the area of laser ablation. A laser beam 309 is then generated to ablate the semiconductor package 301. The laser ablation can be paused when X-ray inspection is required so as to determine if the feature or defect of interest is exposed.

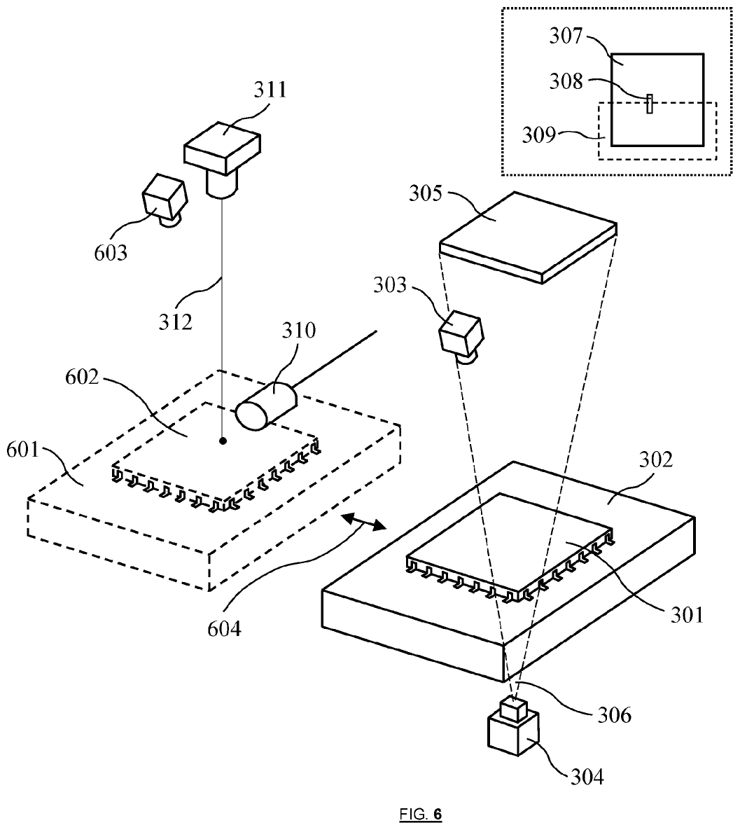

FIG. 6 shows another embodiment of a system where X-ray imaging and laser ablation occurs in turns during the precision micromachining process. In this embodiment, the laser source 311 is installed beside the X-ray source 304 and detector 305. A semiconductor package 301 is mounted onto an X-ray transparent stage 302 at the beginning of the precision micromachining process. In the next step, CCTV 303 facilitates the navigation to the region of interest on the package 301. The semiconductor package 301 and X-ray transparent stage 302 are positioned between the X-ray source 304 and detector 305 during X-ray imaging. After the feature or defect of interest 308 is located from the X-ray image 307 and the pattern 309 to be micromachined is drawn on the X-ray image 307, the semiconductor package 601 and X-ray transparent stage 602 are moved 604 so that the laser source is now directly above the semiconductor package 601. This movement and positioning is guided by a second CCTV 603. The semiconductor package 601 is then laser ablated by a laser beam 311, where the ablation can be paused whenever X-ray inspection is required.

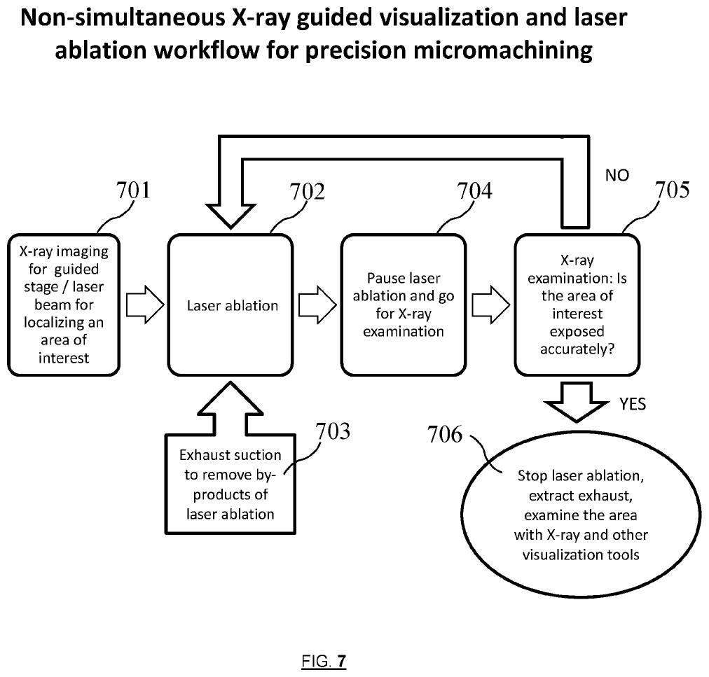

FIG. 7 presents the workflow of the embodiments that are shown in FIGS. 5 and 6, where X-ray imaging and laser ablation occurs in turns during the precision micromachining process. During the precision micromachining process, X-ray imaging is used to locate the area, feature or defect of interest 701. The laser beam is guided by the X-ray imaging to accurately and precisely ablate 702 the area, feature or defect of interest. The by-products generated during laser ablation are removed by a localized exhaust 703. Laser ablation is paused 704 whenever X-ray inspection is required, where the operator will determine if the area, feature or defect of interest is exposed 705 from the X-ray image. The iterative laser ablation 702 and X-ray inspection 704 process continues until the area, feature or defect of interest is exposed 705. The laser ablation process is then ceased 706 and the exposed feature or defect can then be inspected and analyzed by other tools.

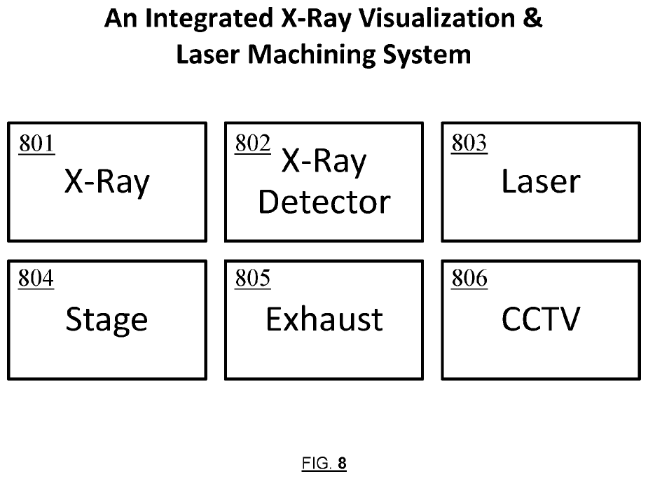

FIG. 8 presents the key apparatuses of the system in accordance with this invention. The X-ray source 801 in this system emits polychromatic X-ray rays that propagate in a cone shape. The X-ray detector 802 is capable of capturing X-ray images of high resolution, where the state-of-the-art technology can achieve submicron resolution. The laser source 803 generates a laser beam that can quickly, accurately and precisely ablate a semiconductor package, while maintaining a small heat affected zone at the laser ablation spot. The X-ray transparent stage 804 allows the polychromatic X-ray to penetrate easily. The localized exhaust 805 removes by-products effectively during the laser ablation process and the CCTV 806 provides large-field-of-views images that enable operators to navigate to the region of interest on the semiconductor package 301. The CCTV 806 also enables the monitoring of the progress of laser ablation in embodiments where X-ray imaging and laser ablation occurs in turns.

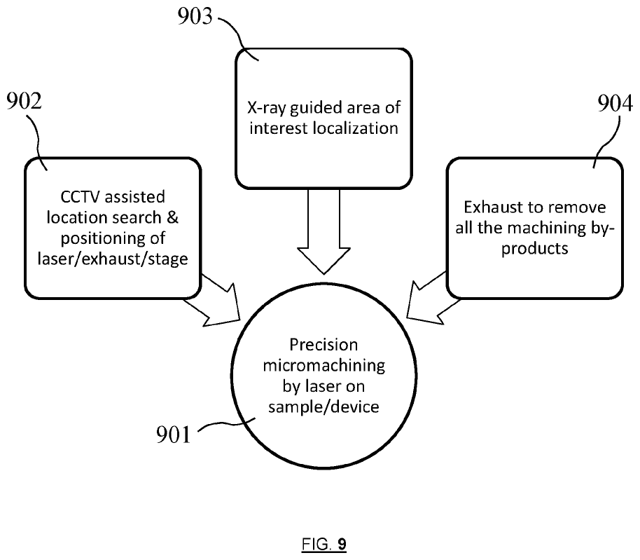

FIG. 9 presents the key features of the system in accordance with this invention. Precision micromachining on a semiconductor package is carried out using laser ablation 901. The high precision can be achieved with the guide provided by X-ray imaging 903. The entire process is assisted by a CCTV that provides large-field-of-view images that helps operators to navigate to the region of interest on the semiconductor package 902. The precision micromachining process also includes the removal of by-products from laser ablation 904.

1. An integrated method and system of using X-ray and laser for precision micromachining.

2. The system as defined in claim 1 comprises of the following:
closed circuit television (CCTV);
X-ray source;
X-ray detector;
laser source;
localized exhaust to achieve clean and precise micromachining;
X-ray transparent stage;
a common chamber where all the key apparatus are installed and integrated;
a computer operating system which allows the laser ablating pattern to be drawn and overlaid on the X-ray image; and
a display system and working table.

3. The system of claim 2, wherein the key apparatuses are CCTV, X-ray source, X-ray detector, laser source, localized exhaust and X-ray transparent stage.

4. The system of claim 2, wherein the combination of CCTV navigation and X-ray imaging are key apparatuses to locate the area of interest, such as a buried special feature or defect;

5. The system of claim 2, wherein X-ray imaging shows the multilayered details inside the sample and bring the embedded key features into focus;

6. The system of claim 2, wherein laser ablation pattern is drawn on embedded features shown in X-ray image;

7. The system of claim 2, wherein a localized exhaust that can be inserted or extracted, and placed at or near the area of the laser machining.

8. The system of claim 2, wherein a localized exhaust that can be adjusted in different angles to the sample surface from 5 degrees to 85 degrees for an optimized exhaustion to remove the by-products from laser machining.

9. The system of claim 2, wherein a localized exhaust that can have different exhaust tip shapes, such as conical, circular, elliptical, rectangular or squarish.

10. The system of claim 2, wherein a localized exhaust tip that can be metal or other materials, and exchangeable based on the machining needs.

11. The method as defined in claim 1 comprises of:
navigating to the region of interest using CCTV;
visually inspecting the sample using X-ray for subsequent micromachining;
locating the buried structure(s) or defect(s) using X-ray imaging and to draw the pattern of laser ablation for precision micromachining;
start laser ablation at the patterned area;
constantly using the X-ray imaging to monitor and control the laser ablation process; and
stop the laser ablation once the desired precision micromachining is achieved.

12. The method of claim 11, wherein the sample is a component of an electronic or electrical equipment that needs to be inspected in cross sectional view.

13. The method of claim 11, wherein the buried structure or defect is imaged using X-ray and cross sectioned using laser ablation to expose the buried structure or defect.

14. The method of claim 11, wherein imaging of the buried structure or defect using X-ray and laser ablation to expose the buried structure or defect using laser occurs simultaneously.

15. The method of claim 14, wherein the beam from laser source to sample and X-ray to sample has a common point on the sample, and the angle between laser beam and X-ray can be at any angle that is from 0 degree to 180 degrees.

16. The method of claim 11, wherein imaging of the buried structure or defect using X-ray and laser ablation to expose the buried structure or defect occurs in turns.

17. The method of claim 16, wherein either the laser apparatus or X-ray apparatus is moved between X-ray imaging and laser ablation.
